(19) United States
(12) Patent Application Publication
(10) Pub. No.: US 2026/0024068 A1
(43) Pub. Date: Jan. 22, 2026

(54) SYSTEMS AND METHODS FOR AUTONOMOUS TELEMETRY ORCHESTRATION

(71) Applicant: BANK OF AMERICA CORPORATION, CHARLOTTE, NC (US)

(72) Inventors: Sneha Padiyar, Mumbai (IN); Maneesh Kumar Sethia, Hyderabad (IN); Kishor Balkrishna Ugale, Mumbai (IN); Siji Jose V, Thrissur (IN)

(73) Assignee: BANK OF AMERICA CORPORATION, CHARLOTTE, NC (US)

(21) Appl. No.: 18/779,599

(22) Filed: Jul. 22, 2024

(51) Int. Cl. G06Q 20/30; G06Q 20/38; G06Q 20/40

(52) U.S. Cl. CPC G06Q 20/308; G06Q 20/386; G06Q 20/4016

(57) ABSTRACT

Systems, computer program products, and methods are described herein for autonomous telemetry orchestration. The present disclosure is configured to initiate and attempt transactions using IoT devices, generate unique session tokens, and verify session details against an orchestration engine by analyzing various parameters such as IP address, device ID, location, operating system, and mobile number. The system conducts a calculated score assessment and compares the score against a predefined threshold to determine transaction legitimacy. Transactions proceed if the score is below the threshold, otherwise, they are halted and alerts are issued. The system dynamically adjusts assessment models using machine learning algorithms based on historical data, employs blockchain technology for unique session tokens, and generates alerts via messaging services for suspicious activities.

### TECHNOLOGICAL FIELD

Example embodiments of the present disclosure relate to autonomous telemetry orchestration.

### BACKGROUND

In recent times, there has been a significant increase in malfeasance through various means such as audio, video, multiple modes, text/SMS, or the like. Malfeasance through internet of things (IoT) devices has become particularly common. The proliferation of deep fake technology further exacerbates this issue, compromising IoT devices and eroding customer trust in transactions conducted via these devices.

Applicant has identified a number of deficiencies and problems associated with autonomous telemetry orchestration. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for autonomous telemetry orchestration. The disclosed solution involves an autonomous telemetry orchestration engine that leverages cognitive artificial intelligence (AI) to analyze time-sensitive data, including geolocation, mobile number, device ID, device intelligence, secure authentication, and SSL. This engine generates a calculated score based on the analysis of these parameters. If the score crosses a predefined threshold, the transaction is stopped, or an alert warning is shared with the customer.

The unique aspects of the invention include the autonomous telemetry orchestration engine's ability to: analyze geolocation data to verify the customer's location against the IoT device's actual location; inspect device IDs to verify the unique identity of connected devices; conduct deep analysis of IP addresses used in transactions to monitor potential issues; implement robust authentication protocols for IoT devices and sessions; ensure secure encrypted communication via SSL between IoT devices and transaction modes; restrict to one NFT per session per IoT device to prevent malfeasance; and generate a calculated score to evaluate transaction safety and trigger necessary actions if thresholds are breached.

The combination of these features makes the invention highly non-obvious and effective in preventing issues, thus building trust with customers using IoT devices for various transactions. The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for autonomous telemetry orchestration, in accordance with an embodiment of the disclosure;

FIG. 2 illustrates an exemplary machine learning (ML) subsystem architecture 200, in accordance with an embodiment of the invention;

FIGS. 3A-3B illustrate an exemplary distributed ledger technology (DLT) architecture, in accordance with an embodiment of the invention;

FIG. 4A illustrates an exemplary process of creating an NFT 400, in accordance with an embodiment of the invention;

FIG. 4B illustrates an exemplary NFT 404 as a multi-layered documentation of a resource, in accordance with an embodiment of an invention; and

FIG. 5 illustrates a process flow for autonomous telemetry orchestration, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “telemetry data” refers to data collected remotely and automatically from various devices, sensors, or systems for monitoring and analysis purposes. Telemetry data may include, but is not limited to, performance metrics, status updates, environmental conditions, and operational parameters.

As used herein, “orchestration engine” refers to a system or software component that autonomously manages the collection, processing, analysis, and utilization of telemetry data. The orchestration engine may employ machine learning algorithms, rule-based systems, or other techniques to optimize telemetry operations.

As used herein, “machine learning algorithm” refers to a type of artificial intelligence that enables systems to learn from data and improve their performance over time without being explicitly programmed. Examples include, but are not limited to, supervised learning, unsupervised learning, and reinforcement learning algorithms.

As used herein, “geolocation” refers to the identification or estimation of the real-world geographic location of an object, such as a device or user, using various data sources, including GPS, IP address, Wi-Fi, and other location-based technologies.

As used herein, “device intelligence” refers to the ability of a device to perform tasks and make decisions based on data analysis, machine learning, or other forms of artificial intelligence. This may include detecting anomalies, predicting failures, or optimizing performance.

As used herein, “authentication” refers to the process of verifying the identity of a device, user, or system component to ensure that it is legitimate and authorized to access or perform certain actions within the system.

As used herein, “SSL” refers to a standard security technology for establishing an encrypted link between a server and a client, ensuring that all data transmitted between them remains private and integral.

As used herein, “calculated score” refers to a numerical value or rating generated by analyzing various parameters, such as geolocation, device ID, device intelligence, and authentication status, to assess the likelihood of bad or malicious activity.

As used herein, “IoT device” refers to a device connected to the Internet or other communication networks, capable of collecting, sending, and receiving data. Examples include smart home devices, wearable technology, industrial sensors, and connected vehicles.

As used herein, “blockchain” refers to a decentralized digital ledger technology that records transactions across multiple computers in such a way that the registered transactions cannot be altered retroactively. This technology ensures transparency, security, and immutability of the data.

As used herein, “session” refers to a period during which an IoT device is actively engaged in communication or data exchange with the orchestration engine. Each session may be uniquely identified and managed to ensure secure and efficient telemetry operations.

As used herein, “threshold” refers to a predefined value or criterion that, when met or exceeded, triggers a specific action or response within the system. For example, a calculated score exceeding a certain threshold may prompt the system to halt transactions or issue an alert.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The present disclosure introduces a system and method for autonomous telemetry orchestration, aimed at enhancing the security and integrity of IoT device transactions through the use of cognitive AI.

In the field of IoT device transactions, there are significant challenges related to ensuring the authenticity and security of data transmissions. The increasing complexity and sophistication of digital interactions have made it essential to develop robust mechanisms to safeguard these transactions against unauthorized access and manipulation.

The solution described herein involves an autonomous telemetry orchestration engine that leverages cognitive AI to analyze time-sensitive data, including geolocation, mobile number, device ID, device intelligence, secure authentication, and SSL. This engine generates a calculated score based on the analysis of these parameters, and if the score exceeds a predefined threshold, the transaction is either halted or an alert is issued to the customer. This approach ensures that only secure and verified transactions are processed, thereby enhancing the overall trust and reliability of IoT device interactions.

Accordingly, the present disclosure describes a solution that includes: analyzing geolocation data to verify the customer's location against the IoT device's actual location; inspecting device IDs to verify the unique identity of connected devices; conducting deep analysis of IP addresses used in transactions to monitor potential issues; implementing robust authentication protocols for IoT devices and sessions; ensuring secure encrypted communication via SSL between IoT devices and transaction modes; restricting to one NFT per session per IoT device to maintain transaction integrity; and generating a calculated score to evaluate transaction safety and trigger necessary actions if thresholds are breached.

What is more, the present disclosure provides a technical solution to a technical problem. As described herein, the technical problem includes ensuring the authenticity and security of IoT device transactions amidst increasing complexity and digital interaction sophistication. The technical solution presented herein allows for the autonomous analysis and orchestration of telemetry data to secure transactions. In particular, the solution is an improvement over existing methods to address these challenges by (i) reducing the number of steps to achieve secure transactions, thereby conserving computing resources such as processing power, storage, and network bandwidth, (ii) providing a more accurate and reliable method of securing transactions, thus minimizing the need for resource-intensive corrections, (iii) eliminating manual input and inefficiencies, thereby improving the speed and efficiency of the process, (iv) optimizing the resource usage to implement the solution, thus reducing network traffic and load on existing systems. Furthermore, the technical solution described herein employs a rigorous, computerized process to perform tasks and activities previously unfeasible, bypassing several traditional steps and further conserving computing resources.

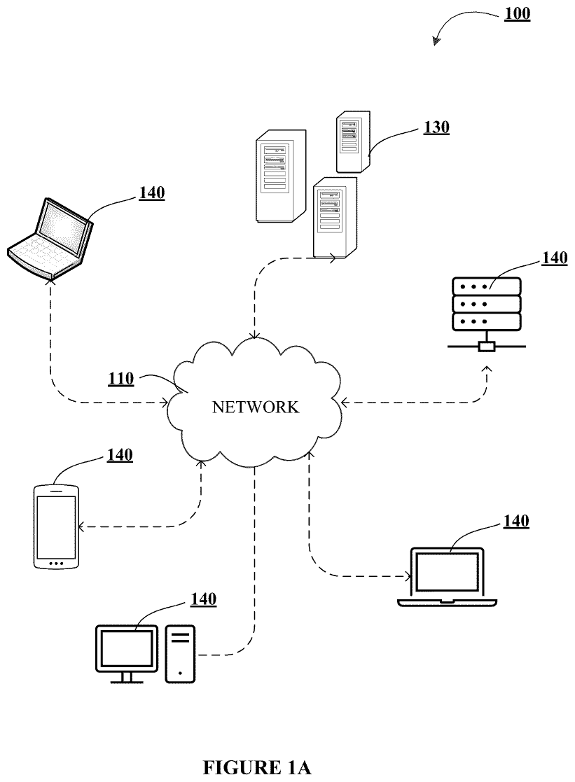

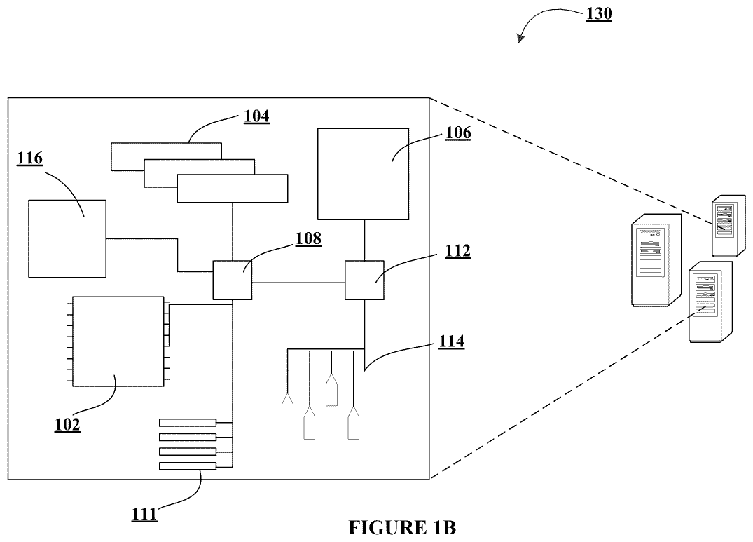

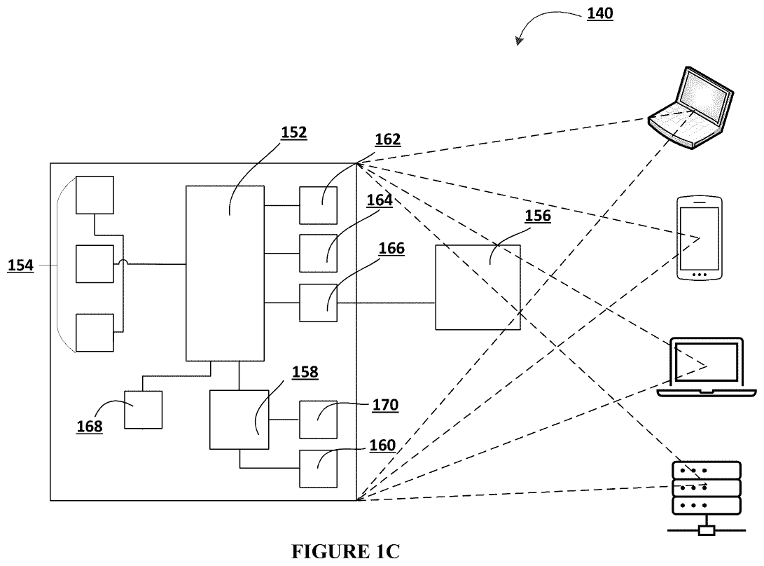

FIGS. 1A-1C illustrate technical components of an exemplary distributed computing environment 100 for autonomous telemetry orchestration, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

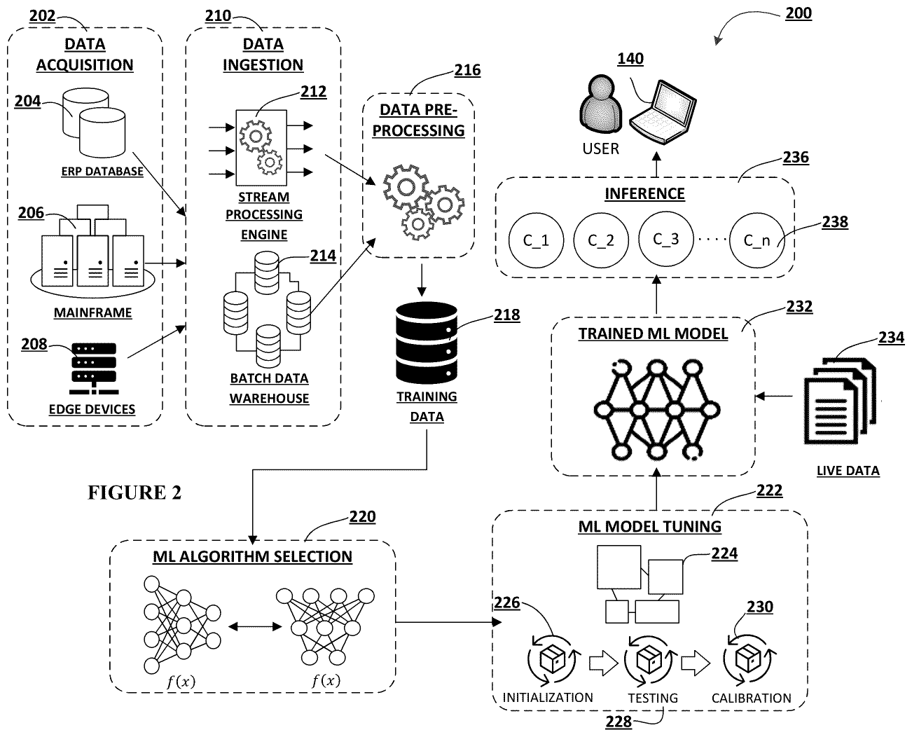

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

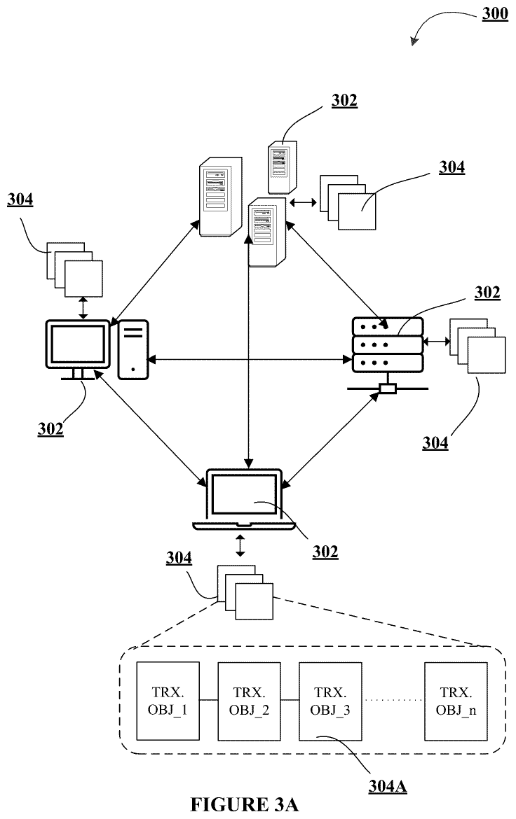

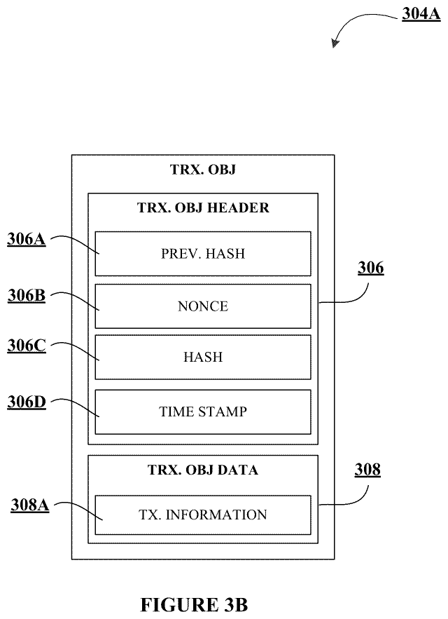

FIGS. 3A-3B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 3A, the exemplary DLT architecture 300 includes a distributed ledger 304 being maintained on multiple devices (nodes) 302 that are authorized to keep track of the distributed ledger 304. For example, these nodes 302 may be computing devices such as system 130 and client device(s) 140. One node 302 in the DLT architecture 300 may have a complete or partial copy of the entire distributed ledger 304 or set of transactions and/or transaction objects 304A on the distributed ledger 304. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 3B, an exemplary transaction object 304A may include a transaction header 306 and a transaction object data 308. The transaction header 306 may include a cryptographic hash of the previous transaction object 306A, a nonce 306B-a randomly generated 32-bit whole number when the transaction object is created, cryptographic hash of the current transaction object 306C wedded to the nonce 306B, and a time stamp 306D. The transaction object data 308 may include transaction information 308A being recorded. Once the transaction object 304A is generated, the transaction information 308A is considered signed and forever tied to its nonce 306B and hash 306C. Once generated, the transaction object 304A is then deployed on the distributed ledger 304. At this time, a distributed ledger address is generated for the transaction object 304A, i.e., an indication of where it is located on the distributed ledger 304 and captured for recording purposes. Once deployed, the transaction information 308A is considered recorded in the distributed ledger 304.

An NFT is a cryptographic record (referred to as “tokens”) linked to a resource. An NFT is typically stored on a distributed ledger that certifies ownership and authenticity of the resource, and exchangeable in a peer-to-peer network.

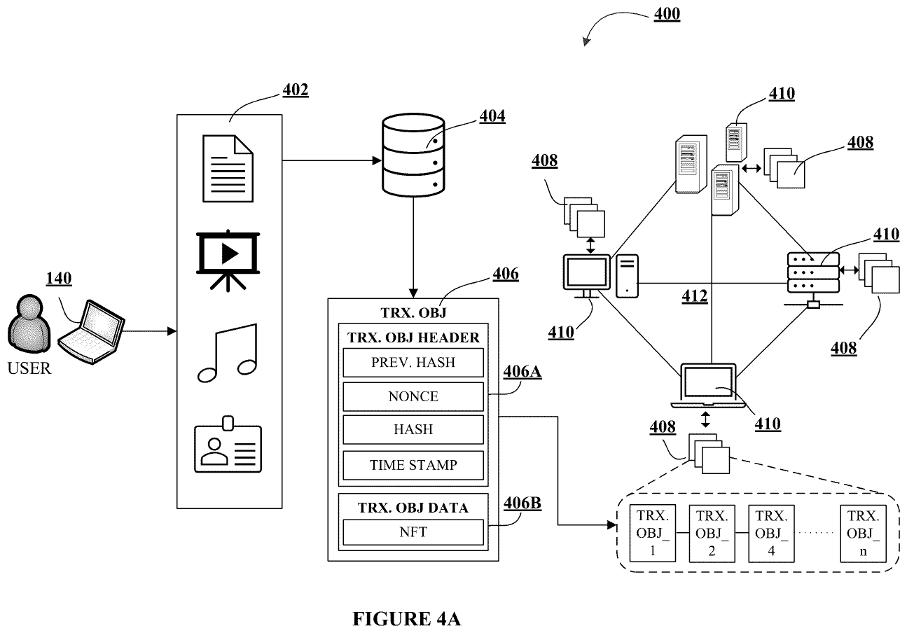

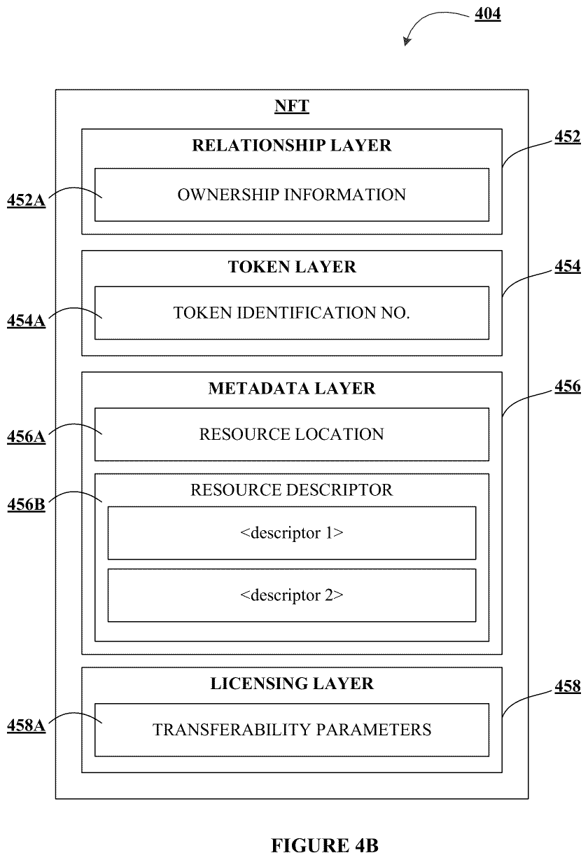

FIG. 4A illustrates an exemplary process of creating an NFT 400, in accordance with an embodiment of the invention. As shown in FIG. 4A, to create or “mint” an NFT, a user (e.g., NFT owner) may identify, using a user input device 140, resources 402 that the user wishes to mint as an NFT. Typically, NFTs are minted from digital objects that represent both tangible and intangible objects. These resources 402 may include a piece of art, music, collectible, virtual world items, videos, real-world items such as artwork and real estate, or any other presumed valuable object. These resources 402 are then digitized into a proper format to produce an NFT 404. The NFT 404 may be a multi-layered documentation that identifies the resources 402 but also evidences various transaction conditions associated therewith, as described in more detail with respect to FIG. 4A.

To record the NFT in a distributed ledger, a transaction object 406 for the NFT 404 is created. The transaction object 406 may include a transaction header 406A and a transaction object data 406B. The transaction header 406A may include a cryptographic hash of the previous transaction object, a nonce-a randomly generated 32-bit whole number when the transaction object is created, cryptographic hash of the current transaction object wedded to the nonce, and a time stamp. The transaction object data 406B may include the NFT 404 being recorded. Once the transaction object 406 is generated, the NFT 204 is considered signed and forever tied to its nonce and hash. The transaction object 406 is then deployed in the distributed ledger 408. At this time, a distributed ledger address is generated for the transaction object 406, i.e., an indication of where it is located on the distributed ledger 408 and captured for recording purposes. Once deployed, the NFT 404 is linked permanently to its hash and the distributed ledger 408, and is considered recorded in the distributed ledger 408, thus concluding the minting process

As shown in FIG. 4A, the distributed ledger 408 may be maintained on multiple devices (nodes) 410 that are authorized to keep track of the distributed ledger 408. For example, these nodes 410 may be computing devices such as system 130 and end-point device(s) 140. One node 410 may have a complete or partial copy of the entire distributed ledger 408 or set of transactions and/or transaction objects on the distributed ledger 408. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 4B illustrates an exemplary NFT 404 as a multi-layered documentation of a resource, in accordance with an embodiment of an invention. As shown in FIG. 4B, the NFT may include at least relationship layer 452, a token layer 454, a metadata layer 456, and a licensing layer 458. The relationship layer 452 may include ownership information 452A, including a map of various users that are associated with the resource and/or the NFT 404, and their relationship to one another. For example, if the NFT 404 is purchased by buyer B1 from a seller S1, the relationship between B1 and S1 as a buyer-seller is recorded in the relationship layer 452. In another example, if the NFT 404 is owned by O1 and the resource itself is stored in a storage facility by storage provider SP1, then the relationship between O1 and SP1 as owner-file storage provider is recorded in the relationship layer 452. The token layer 454 may include a token identification number 454A that is used to identify the NFT 404. The metadata layer 456 may include at least a file location 456A and a file descriptor 456B. The file location 456A may provide information associated with the specific location of the resource 402. Depending on the conditions listed in the smart contract underlying the distributed ledger 408, the resource 402 may be stored on-chain, i.e., directly on the distributed ledger 408 along with the NFT 404, or off-chain, i.e., in an external storage location. The file location 456A identifies where the resource 402 is stored. The file descriptor 456B may include specific information associated with the source itself 402. For example, the file descriptor 456B may include information about the supply, authenticity, lineage, provenance of the resource 402. The licensing layer 458 may include any transferability parameters 458B associated with the NFT 404, such as restrictions and licensing rules associated with purchase, sale, and any other types of transfer of the resource 402 and/or the NFT 404 from one person to another. Those skilled in the art will appreciate that various additional layers and combinations of layers can be configured as needed without departing from the scope and spirit of the invention.

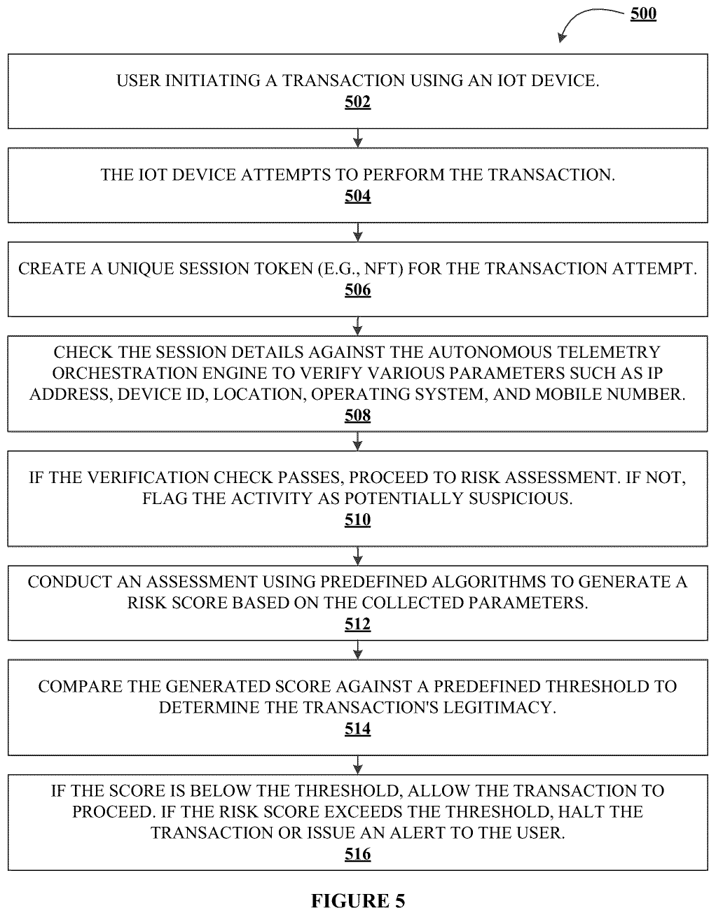

FIG. 5 illustrates a process flow for autonomous telemetry orchestration, in accordance with an embodiment of the disclosure. As shown in block 502, in the first step, a user initiates a transaction using an IoT device. This IoT device could be a smartphone, a wearable device, a smart home appliance, or any other internet-connected device capable of performing transactions. The initiation process typically involves the user interacting with a software application or web interface on the IoT device. The software application is developed using programming languages such as Java, Swift, or Kotlin for mobile devices, or HTML, CSS, and JavaScript for web interfaces. The user's action triggers an API call to the backend server, which logs the transaction request. The system architecture ensures secure communication between the IoT device and the backend server using encryption protocols such as SSL/TLS.

As shown in block 504, once the transaction is initiated, the IoT device attempts to perform the transaction by sending a request to the backend server. This request includes relevant transaction details such as user credentials, transaction amount, and device metadata. The backend server, typically built on a robust framework like Node.js, Django, or Spring Boot, processes the incoming request. The server verifies the request format and content, ensuring all necessary data is present. The communication between the IoT device and server employs RESTful APIs, allowing efficient and stateless interactions. Additionally, the server logs the transaction attempt for auditing and monitoring purposes.

As shown in block 506, upon receiving the transaction attempt, the system generates a unique session token for the transaction. This token, which can be an NFT (Non-Fungible Token), ensures the uniqueness and traceability of each transaction session. The token generation process utilizes blockchain technology, leveraging platforms like Ethereum or Hyperledger for creating and managing NFTs. Smart contracts, written in languages such as Solidity or Chaincode, handle the creation and validation of these tokens. The session token is then associated with the transaction request and stored in a secure, distributed ledger. This ensures the immutability and transparency of transaction records.

As indicated in block 508, the session details are checked against the Autonomous Telemetry Orchestration engine to verify various parameters such as IP address, device ID, location, operating system, and mobile number. The orchestration engine is powered by advanced machine learning algorithms and runs on a cloud infrastructure like AWS, Azure, or Google Cloud. The engine aggregates and analyzes telemetry data from multiple sources in real-time. It uses Python or R for data analysis, and TensorFlow or PyTorch for implementing machine learning models. The verification process involves cross-referencing the session details with known patterns of legitimate and suspicious activities. The orchestration engine flags any discrepancies or anomalies for further investigation.

As shown in block 510, if the session details pass the verification check, the system proceeds to the assessment phase. Otherwise, the activity is flagged as potentially suspicious. The flagging process involves updating the transaction status in the backend database, which can be a SQL or NoSQL database such as PostgreSQL, MongoDB, or Cassandra. The backend server triggers an alert to the user and the system administrators, notifying them of the suspicious activity. The alert mechanism can be implemented using messaging services like Twilio for SMS alerts, or Firebase for push notifications. Additionally, the flagged transaction is logged and stored for further analysis and potential manual review.

As indicated in block 512, the system conducts an assessment using predefined algorithms to generate a calculated score based on the collected parameters. These algorithms, developed using machine learning and statistical techniques, evaluate the likelihood of the transaction being legitimate or bad. Features such as transaction amount, user behavior, device telemetry, and historical data are input into the model. The assessment engine may use supervised learning models like logistic regression, decision trees, or neural networks, implemented using frameworks like Scikit-learn or Keras. The generated calculated score quantifies the calculated level, with higher scores indicating higher potential for bad activity.

As shown in block 514, the generated calculated score is compared against a predefined threshold to determine the transaction's legitimacy. The threshold is set based on historical data and tolerance levels defined by the system administrators. If the calculated score exceeds the threshold, the transaction is considered suspicious and subject to further scrutiny. The comparison operation is performed in real-time, ensuring minimal delay in transaction processing. The threshold values and comparison logic are stored in a configuration management system, allowing dynamic updates without disrupting the system's operations. This process ensures that only legitimate transactions are approved, enhancing the security and reliability of the system.

As shown in block 516, if the calculated score is below the threshold, the transaction is allowed to proceed. Otherwise, the transaction is halted, and an alert is issued to the user. The decision to proceed or halt the transaction is recorded in the backend database, along with the calculated score and assessment details. For allowed transactions, the system completes the transaction process by updating the relevant records and notifying the user of the successful transaction. For halted transactions, the user is informed of the issue, and guidance is provided on next steps, such as verifying their identity or contacting customer support. The alert mechanism ensures that users and administrators are aware of any potential issues, enabling prompt resolution and maintaining trust in the system.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for autonomous telemetry orchestration, the system comprising:
a processing device;
a non-transitory storage device containing instructions when executed by the processing device, causes the processing device to perform the steps of:
initiating a transaction using an internet of things (IoT) device;
attempting to perform the transaction by sending a transaction request from the IoT device to a backend server;
creating a unique session token for the transaction attempt, wherein the unique session token is a Non-Fungible Token (NFT) created using blockchain technology to ensure the uniqueness and traceability of each transaction session;
verifying session details against an autonomous telemetry orchestration engine by analyzing parameters including internet protocol (IP) address, device identification number, location, operating system, and mobile number;
conducting a calculated score assessment to generate a calculated score based on verifying session details;
comparing the generated calculated score against a predefined threshold to determine legitimacy of the transaction; and
proceeding with the transaction if the calculated score is below the threshold, or halting the transaction and issuing an automatic alert if the calculated score exceeds the threshold to a user device associated with the IoT device and to administrators for verification of identification.

2. The system of claim 1, wherein the system is further configured to: employ machine learning algorithms to dynamically adjust an assessment model based on historical transaction data and detected patterns of legitimate and suspicious activities.

3. The system of claim 2, wherein the machine learning algorithms are selected from the group consisting of logistic regression, decision trees, and neural networks.

4. (canceled)

5. The system of claim 1, wherein the predefined threshold for the calculated score is dynamically adjustable based on real-time analysis of transaction data and tolerance levels set by one or more system administrators.

6. The system of claim 1, wherein the verification of session details involves cross-referencing with a database of known legitimate and suspicious parameters stored on a cloud infrastructure.

7. The system of claim 1, wherein the system is further configured to: generate alerts using messaging services to notify users and administrators of suspicious transaction activities, wherein the messaging services are selected from the group consisting of SMS, push notifications, and email alerts.

8. A computer program product for autonomous telemetry orchestration, the computer program product comprising a non-transitory computer-readable medium comprising code causing an apparatus to:
initiating a transaction using an internet of things (IoT) device;
attempting to perform the transaction by sending a transaction request from the IoT device to a backend server;
creating a unique session token for the transaction attempt, wherein the unique session token is a Non-Fungible Token (NFT) created using blockchain technology to ensure the uniqueness and traceability of each transaction session;
verifying session details against an autonomous telemetry orchestration engine by analyzing parameters including internet protocol (IP) address, device identification number, location, operating system, and mobile number;
conducting a calculated score assessment to generate a calculated score based on verifying session details;
comparing the generated calculated score against a predefined threshold to determine legitimacy of the transaction; and
proceeding with the transaction if the calculated score is below the threshold, or halting the transaction and issuing an automatic alert if the calculated score exceeds the threshold to a user device associated with the IoT device and to administrators for verification of identification.

9. The computer program product of claim 8, wherein the code further causes the apparatus to: employ machine learning algorithms to dynamically adjust an assessment model based on historical transaction data and detected patterns of legitimate and suspicious activities.

10. The computer program product of claim 9, wherein the machine learning algorithms are selected from the group consisting of logistic regression, decision trees, and neural networks.

11. (canceled)

12. The computer program product of claim 8, wherein the predefined threshold for the calculated score is dynamically adjustable based on real-time analysis of transaction data and tolerance levels set by one or more system administrators.

13. The computer program product of claim 8, wherein the verification of session details involves cross-referencing with a database of known legitimate and suspicious parameters stored on a cloud infrastructure.

14. The computer program product of claim 8, wherein the system is further configured to: generate alerts using messaging services to notify users and administrators of suspicious transaction activities, wherein the messaging services are selected from the group consisting of SMS, push notifications, and email alerts.

15. A method for autonomous telemetry orchestration, the method comprising:
initiating a transaction using an internet of things (IoT) device;
attempting to perform the transaction by sending a transaction request from the IoT device to a backend server;
creating a unique session token for the transaction attempt, wherein the unique session token is a Non-Fungible Token (NFT) created using blockchain technology to ensure the uniqueness and traceability of each transaction session;
verifying session details against an autonomous telemetry orchestration engine by analyzing parameters including internet protocol (IP) address, device identification number, location, operating system, and mobile number;
conducting a calculated score assessment to generate a calculated score based on verifying session details;
comparing the generated calculated score against a predefined threshold to determine legitimacy of the transaction; and
proceeding with the transaction if the calculated score is below the threshold, or halting the transaction and issuing an automatic alert if the calculated score exceeds the threshold to a user device associated with the IoT device and to administrators for verification of identification.

16. The method of claim 15, wherein the method further comprises: employ machine learning algorithms to dynamically adjust an assessment model based on historical transaction data and detected patterns of legitimate and suspicious activities.

17. The method of claim 16, wherein the machine learning algorithms are selected from the group consisting of logistic regression, decision trees, and neural networks.

18. (canceled)

19. The method of claim 15, wherein the predefined threshold for the calculated score is dynamically adjustable based on real-time analysis of transaction data and tolerance levels set by one or more system administrators.

20. The method of claim 15, wherein the verification of session details involves cross-referencing with a database of known legitimate and suspicious parameters stored on a cloud infrastructure.
